(19) United States
(12) Patent Application Publication
(10) Pub. No.: US 2020/0193371 A1
(43) Pub. Date: Jun. 18, 2020

(54) Method and System for Providing an On-Demand Package Delivery Service by Generating an Indicator between a Requester and a Means of Transportation

(71) Applicant: Oldine Jean-Charles, Atlanta, GA (US)

(72) Inventor: Oldine Jean-Charles, Atlanta, GA (US)

(21) Appl. No.: 16/719,711

(22) Filed: Dec. 18, 2019

Related U.S. Application Data
(60) Provisional application No. 62/781,590, filed on Dec. 18, 2018.

(51) Int. Cl. G06Q 10/08; G06Q 50/00

(52) U.S. Cl. CPC G06Q 10/0833; G06Q 50/01

(57) ABSTRACT

A method manages an online on-demand errand service. The method allows a user to request various types of errand and grants a service provider temporary access to a payment account for purchasing items for the user. The method enables the user to place online orders and have the items delivered to any desired location. For every errand, the method offers a real-time tracking of all items through the service provider's personal computing (PC) device, a bar-code system, or a QR (quick response) system. Upon delivery, the method provides a secure confirmation process using delivery photos and one-time-password (OTP) code to close the errand request. The method further offers a service assistant that is integrated into every stage of the process and implemented with artificial intelligence technologies, thus offering versatile and powerful functions to efficiently and effectively manage the errand services while securing every errand and transaction with maximum security.

The current application claims a priority to the U.S. Provisional Patent application Ser. No. 62/781,590 filed on Dec. 18, 2018.

### FIELD OF THE INVENTION

The present invention relates generally to errand management systems. More specifically, the present invention manages an on-demand errand system by providing a process to request various types of errand, grant a service provider temporary access to a payment account to pay for items on behalf of the user, track all items for each errand, and manages secure confirmations upon the completion of each errand. The present invention further provides a service assistant to interact with a user to generate errand requests, tracking errands in real-time, and confirming the completion of errands between the user and the service provider using artificial intelligence technologies.

### BACKGROUND OF THE INVENTION

Errand is usually referred to as a short journey taken to perform some necessary task or duty. For example, errands may be taking or fetching clothes from a dry-cleaning shop, taking mails to the post office, taking sacks of leaves to a compost center, returning a purchased item, etc. In present society, there is a growing need for personal errand services. What would have in some circles been considered simple laziness generations ago is now considered a necessity in people's daily lives. Many people are now overloaded with busy lifestyles. People are working harder, spending less time, at home, and finding fewer hours available to them to get some errands completed. Errand service has been becoming valuable to millions of people providing virtually any task that might be needed. Running to get some coffee is just one aspect of this type of service. Someone might need an errand service provider to pick up their grocery pre-ordered online and deliver it by a specific time. A company might hire an errand provider to pick up marketing materials that are printed weekly. As people get older, they become less capable of managing daily tasks, such as grocery shopping, picking up prescription medicine, and more. Senior citizens often hire errand runners to do the tasks they no longer can, or want to, do. Overall, the errand service industry is growing rapidly.

Most errand services focused on delivery-based tasks, one of which is grocery delivery service provided by supermarkets, grocery store, large chains such as Whole Foods® and Sam's Club®, etc. For this type of delivery service, a user is allowed to shop online and send the order with an anticipated pickup time or delivery time window. Many retailer stores, however, are providing this service to accommodate their customers. The user cannot ask the delivery service provider to add something else, such as a piece of drywall into the items to be delivered. Thus, this type of grocery delivery lacks flexibility for combining user desired items that are not available in a specific retailer store. Further, the user may not be able to order something to be delivered in a very short time window, for example, within an hour. The order and delivery request must be completed with a fairly long time window for the specific provider to get ready the items and run the route for delivery.

Most online errand service providers can provide various services ranging from home goods delivery, home cleaning and organization, event planning, travel arrangement, appointment setting, Internet research, etc. Most of existing online errand service providers, however, have many drawbacks and problems. Firstly, many providers do not offer any purchasing activities to the user on the user's behalf. For example, a user may desire certain grocery items to be most fresh, of highest quality, thus specify the items for an errand runner to purchase them in a local store on their behalf. Secondly, many providers may not offer services in a tight time window such as within one hour, two hours, same day, etc. Thirdly, most providers use delivery systems and mobile apps which may not have adopted the most secure delivery confirmation methods and technologies to safeguard the delivery and minimize or eliminate disputes. For example, a 2000 research published in the Associated Press (on May 31, 2000), titled “Deliveries Try to Keep Up with Online Shopping” reported 25 percent of all residential deliveries in 1999, 250,000 attempted deliveries of consumer goods to homes, failed on a first attempt, resulting a large number of goods left unattended on doorsteps and making these goods vulnerable to theft and/or loss. Fourthly, most providers use processes that deliver a single package per errand run without any batching or integration of multiple packages from multiple pickups to achieve efficient operations. These processes may lead to high per package costs, thus better scheduling and routing systems may be needed to improve the overall efficiency of the errand services.

It is an objective of the present invention to provide a solution to the aforementioned drawbacks and problems of the existing errand services. The present invention provides a method and system that manages an online on-demand errand service which secures every errand running, increases efficiency and consumer convenience, reduces cost, and facilitates last-minute needs of consumers. Additionally, the present invention incorporates a service assistant to interact with a user to generate errand requests, tracking errands in real-time, and confirming the completion of errands between the user and the service provider using artificial intelligence technologies.

### SUMMARY OF THE INVENTION

An online method of the present invention manages an on-demand errand service platform for a user. The method of the present invention provides a process to the user to request various types of errand, including, but not limited to, picking up items from a location and delivering the items to another location, both of which are specified by the user. The user may request the pickup from the user's location, or other location. The delivery location can be a business for the purpose such as returning a purchased item for the user, delivering marketing brochures, business supplies, etc. The user is allowed to specify desired errand completion time window, including, but not limited to, one-hour, two-hour, same day, overnight, etc. Each errand request entered by the user may include multiple errands that involve various pickup and delivery locations, which can be combined into an optimized route for an errand servicer provider, also named “service provider”, by the errand service method of the present invention.

The method of the present invention grants a service provider temporary access to a payment account of the user to pay for desired items at a business location, including, but not limited to a store such as grocery store, department store, dry-cleaning store, eCommerce (electronic commerce) stores, online stores, Internet stores, etc., and deliver to a location the user specifies, for example, the user's location, or any other user desired location. Once the purchase is completed, the method revokes the access to the user's account to safeguard the account from any fraud. The method also enables the user to make online or phone orders and have the ordered items picked up and delivered to any desired location that the user specifies.

For every errand, the method of the present invention offers a real-time continuous tracking of all items by means including, but not limited to, the service provider's personal computing (PC) device, a bar-code system, or a QR (quick response) system. Once the delivery is made, the method provides the user with a secure process to close the errand request through confirmations from both the service provider and the user. The service provider first initializes the confirmation of delivery by sending at least one photo of the delivery to the user. Once the user reviews and confirms the right delivery was made within the requested time window, the user confirms through the method. Subsequently, the method creates an OTP (One-Time-Password) code and sends it to the service provider to close out on the corresponding PC device the errand request, thus allowing the system to release the specific service provider from the current errand request and to move to the next.

Additionally, the present invention offers a service assistant that is integrated into every stage of the errand service process. The service assistant functions as a smart online helper that interacts with the user to generate errand requests through each step requiring specific user information, preferences, requirements, and specific errand needs. Subsequently, the service assistant offers efficient tracking of errands in real-time, and confirming the completion of errands between the user and the service provider using artificial intelligence technologies.

Thus, the errand service method and system of the present invention offers an effective and powerful online on-demand process that secures every errand running, increases efficiency and consumer convenience, reduces cost, facilitates last-minute user needs, and optimizes the user's experience at every step of the process through the most advanced technologies.

### BRIEF DESCRIPTION OF THE DRAWINGS

FIG. 1 is a system diagram of the method of the present invention.

FIG. 2 is an overall flowchart of a method to manage online on-demand errand services of the present invention.

FIG. 3 is a flowchart of a sub-process of receiving user errand request of the method of the present invention.

FIG. 4 is a flowchart of an embodiment of the sub-process of receiving user errand request of the method of the present invention.

FIG. 5 is a flowchart of another embodiment of the sub-process of receiving user errand request of the method of the present invention.

FIG. 6 is a flowchart of another embodiment of the sub-process of receiving user errand request of the method of the present invention.

FIG. 7 is a flowchart of a sub-process of selecting a completion time for an errand of the method of the present invention.

FIG. 8 is a flowchart of a sub-process of specifying a range for the search of a service provider for an errand of the method of the present invention.

FIG. 9 is a flowchart of an embodiment of the sub-process of specifying at least one special request for the search of a service provider for an errand of the method of the present invention.

FIG. 10 is a flowchart of a sub-process of specifying a payment account and maximum monetary amount for paying for desired items by a service provider on behalf of a consumer of the method of the present invention.

FIG. 11 is a flowchart of a sub-process of continuously tracking errands of the method of the present invention.

FIG. 12 is a flowchart of a sub-process of closing errands of the method of the present invention.

FIG. 13 is a flowchart of an embodiment of the sub-process of closing errands of the method of the present invention.

FIG. 14 is an alternative embodiment of the system diagram of the method of the present invention, wherein a service assistant is included.

FIG. 15 is a flowchart of a sub-process of providing the service assistant to the specific user of the method of the present invention.

FIG. 16 is a flowchart of a sub-process of generating an errand request using the service assistant of the method of the present invention.

FIG. 17 is a flowchart of an alternative embodiment of the sub-process of generating an errand request using the voice assistance of the service assistant of the method of the present invention.

FIG. 18 is a flowchart of a sub-process of providing tracking assistance the service assistant of the method of the present invention.

FIG. 19 is a flowchart of a sub-process of providing confirmation assistance the service assistant of the method of the present invention.

### DETAIL DESCRIPTIONS OF THE INVENTION

All illustrations of the drawings are for the purpose of describing selected versions of the present invention and are not intended to limit the scope of the present invention.

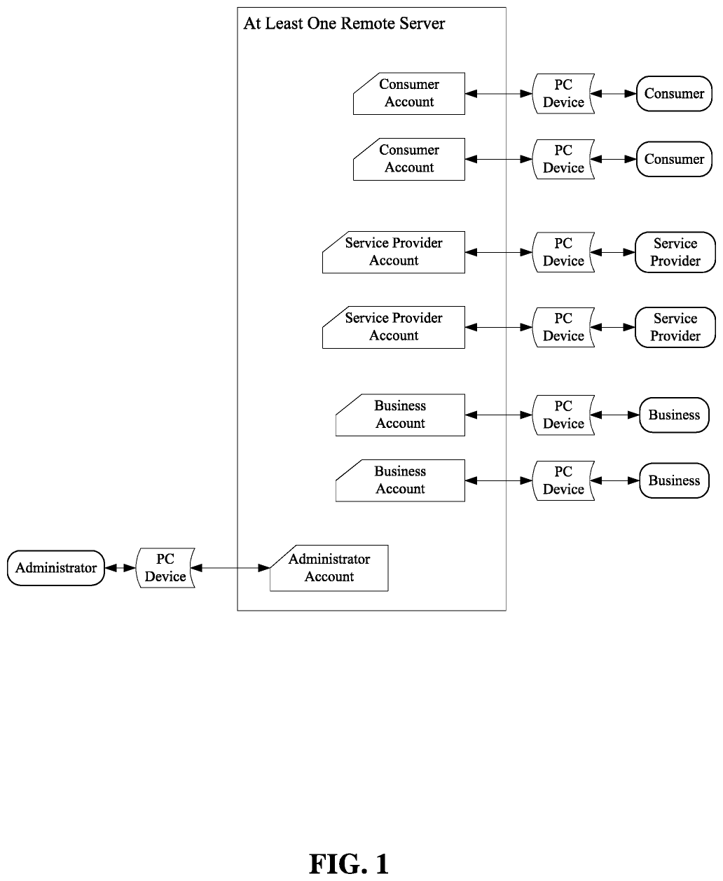

As can be seen in FIG. 1 to FIG. 12, the present invention comprises a method and system that manages an online on-demand errand system. The method of the present invention provides a process to a user to request various types of errand, including, but not limited to, picking up items from a location and delivering the items to another location, both of which are specified by the user. The user is allowed to specify desired errand completion time window, including, but not limited to, one-hour, two-hour, say day, overnight, etc. Each errand request entered by the user may include multiple errands that involve various pickup and delivery locations, which can be combined into an optimized route for an errand servicer provider, also named “service provider”, by the errand service method of the present invention. Additionally, errand service method grants a service provider temporary access to a payment account of the user to pay for desired items at a business location, including, but not limited to a store such as grocery store, department store, dry-cleaning store, etc., and deliver to a location the user specifies. At the completion of the purchase, the method revokes the access to the user's account to safeguard the account. The user is enabled make online or phone orders and have the ordered items picked up and delivered to any desired location. For every errand, the errand service method offers a real-time continuous tracking of all items by means including, but not limited to, the service provider's personal computing (PC) device, a bar-code system, or a QR (quick response) system. Once the delivery is made, the errand service method provides the user with a secure process to close the errand request through confirmations from both the service provider and the user using an OTP (One-Time-Password) code and thus allowing the system to release the specific service provider from the current errand request and to move to the next. Further, the present invention integrates a service assistant that offers powerful assistance to the user at every stage of the errand service process. Implemented with the most advanced artificial intelligence technologies, including, but not limited to, natural language learning, deep machine learning, meta learning, etc., the service assistant functions as a smart online helper that interacts with the user to generate errand requests through each step requiring specific user information, preferences, requirements, and specific errand needs. Subsequently, the service assistant offers efficient tracking and instant notification of errand status in real-time, and confirming the completion of errands between the user and the service provider using artificial intelligence technologies.

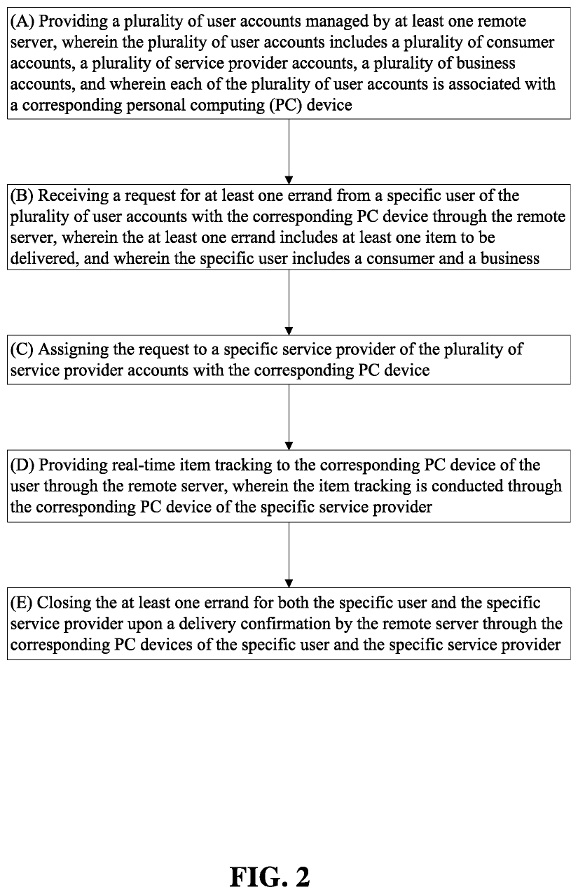

As can be seen in FIG. 1, the method of the present invention provides an on-demand errand service management platform between multiple users. To accomplish this, the errand service method of the present invention provides a plurality of user accounts managed by at least one remote server, wherein the plurality of user accounts includes a plurality of consumer accounts, a plurality of service provider accounts, a plurality of business accounts, and wherein each of the plurality of user accounts is associated with a corresponding personal computing (PC) device (Step A) as seen in FIG. 2. The corresponding user PC device allows a user to interact with the present invention and can be, but is not limited to, a smartphone, a smart watch, a laptop, a desktop, a server computer, or a tablet PC. Additionally, the corresponding user PC device may include software applications including, but not limited to, mobile apps, computer software, computer applications, cloud applications, client software applications, etc. The consumers of the consumer accounts include, but are not limited to, relevant parties such as, but are not limited to, general public individuals, professions, businesses, business owners, managers, government entities, officers, officials, service providers, etc. The service providers of the service provider accounts may include, but are not limited to, individuals, employees, contractors, drivers, taxi drivers, delivery professionals, logistic providers, administrators, self-driving cars, self-driving devices, self-driving machines, robots, drones, the like, etc. The businesses of the business accounts may include, but are not limited to, stores such as dry-cleaning stores, grocery stores, department stores, convenient stores, jewelry stores, shore stores, electronics stores, hardware stores, building supply stores, computer stores, appliance stores, corporations, government entities, administrators, etc. Further, the at least one remote server is used to manage method between the plurality of user accounts. The remote server can be managed through an administrator account by an administrator as seen in FIG. 1. Moreover, the remote server is used to execute a number of internal software processes and store data for the present invention. The software processes may include, but are not limited to, server software programs, cloud software programs, web-based software applications or browsers embodied as, for example, but not be limited to, websites, web applications, cloud applications, desktop applications, and mobile applications compatible with the corresponding user PC devices. Additionally, the software processes may store data into internal databases and communicate with external databases, which may include, but are not limited to, map databases such as Google Maps®, Apple Maps®, etc., service provider databases, databases maintaining user information, databases maintaining driver information, databases maintaining business information, databases maintaining service provider information, etc. The interaction with external databases over a communication network may include, but is not limited to, the Internet, wireless network, wifi (wireless fidelity), Bluetooth®.

As can be seen in FIG. 2, the overall process of the errand service method used to manage online on-demand errand services of the present invention starts with receiving a request for at least one errand from a specific user of the plurality of user accounts with the corresponding PC device through the remote server, wherein the at least one errand includes at least one item to be delivered, and wherein the specific user includes a consumer and a business (Step B). Specifically, the errand service method allows the specific user such as a consumer or a business to enter a request for at least one errand for delivering at least one item specified by the user. The at least one item desired by the specific user may be picked up at a location per the user's request or purchased on the user's behalf by a service provider.

As can be seen in FIG. 2, the errand service method subsequently assigns the request to a specific service provider of the plurality of service provider accounts with the corresponding PC device (Step C). The assignment of errands may be performed based on, including, but not limited to, geographical vicinity of the specific user, a range of area specified by the user, special conditions per the user, etc. Further, the errand service method may assign errands to specific service providers based on conditions including, but not limited to, the availability of the service providers, matching of service providers of specific user requirements, time window for errands, etc.

As can be seen in FIG. 2, the errand service method provides real-time item tracking to the corresponding PC device of the user through the remote server, wherein the item tracking is conducted through the corresponding PC device of the specific service provider (Step D). With applications including, but not limited to, mobile apps, software applications, etc., installed on PC devices, the errand service method can provide actual/real-time tracking of the status of each errand in progress.

As can be seen in FIG. 2, the errand service method closes the at least one errand for both the specific user and the specific service provider upon a delivery confirmation by the remote server through the corresponding PC devices of the specific user and the specific service provider (Step E). The present invention offers an optimized method to secure the confirmation and closing of each errand and can eliminate or minimize disputes between the specific user and the specific service provider.

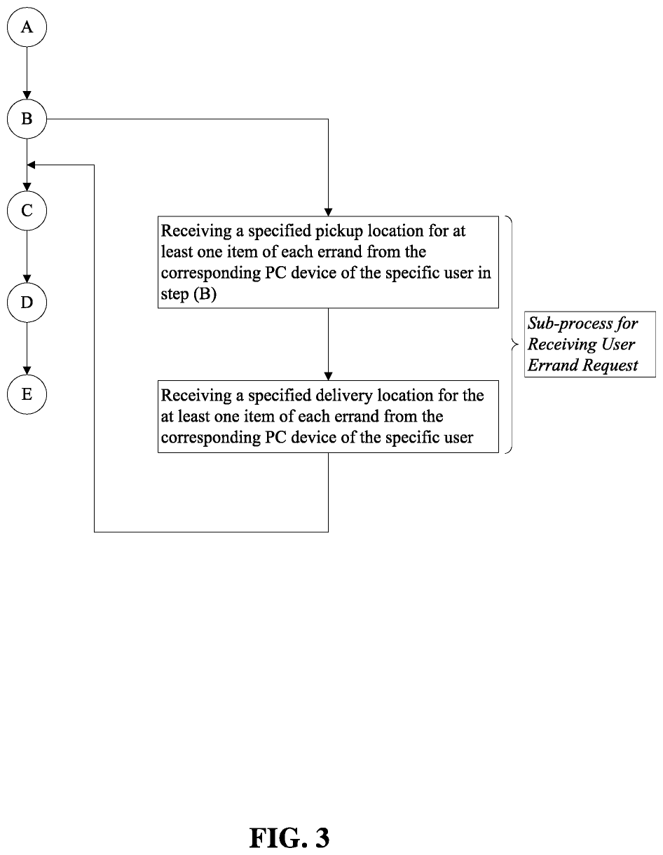

As can be seen in FIG. 3, in an embodiment of the present invention, the errand service method of the present invention provides a sub-process to receive user errand request of a specific user. The embodiment of the errand service method receives a specified pickup location for at least one item of each errand from the corresponding PC device of the specific user in Step B, and then receives a specified delivery location for the at least one item of each errand from the corresponding PC device of the specific user. More specifically, this sub-process allows the user enters general errand requests including, but not limited to, errands of delivering items form the user's location to another location that the user specifies, errands of picking up items the user ordered from a business including, but not limited to, store, e-store (electronic store), eCommerce (electronic commerce) store, online store, Internet store, corporation, retailer, warehouse, etc., and delivering to the user's location or any other locations the user specifies. In a single request, the user can enter one errand, or multiple requests. Additionally, each request comprises at least one errand, which specifies the pickup location, delivery location, descriptions of items, quantity of items, etc. Further, for multiple errands, the errand service method can generate am optimized route for the service provider to follow and allows the service provider to design a custom route for the errands of the request.

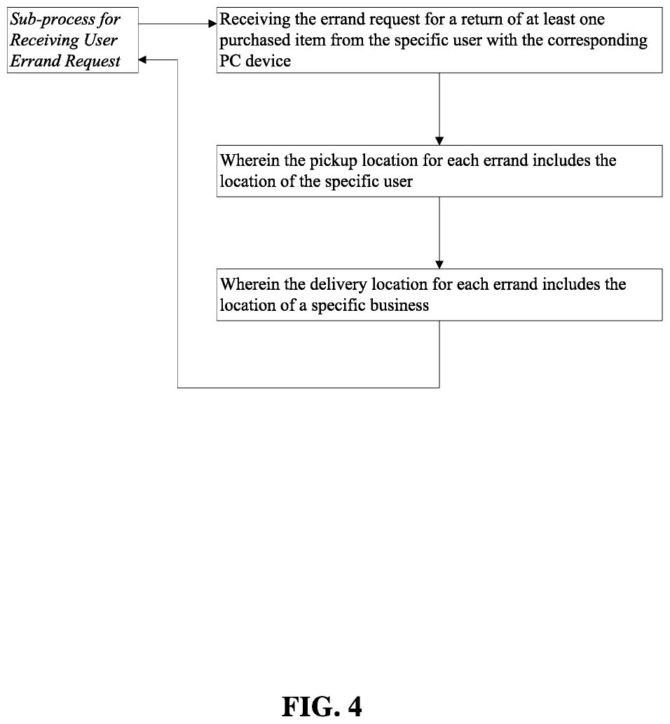

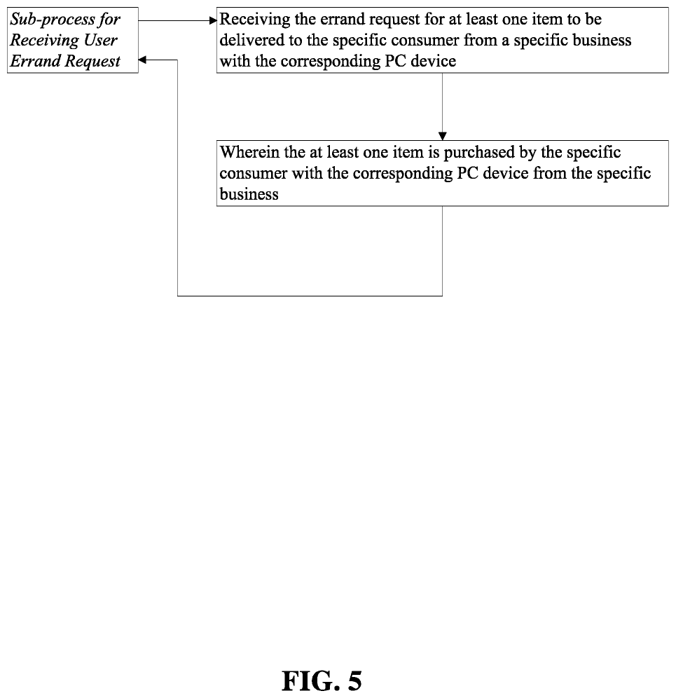

As can be seen in FIG. 4, in another embodiment of the present invention, the errand request sub-process of the errand service method receives the errand request for a return of at least one purchased item from the specific user with the corresponding PC device, wherein the pickup location for each errand includes the location of the specific user, and wherein the pickup location for each errand includes the location of the specific user. More specifically, the errand service method implements a purchased item return sub-process so that the user can use a specific service provider to pick up any item purchased for return to the vendor, store, business, etc. The purchased item can be any item from online shopping thus acquired through home delivery, or from a purchase from a local store, or business. Additionally, the user may provide prepackaged return item using a return shipping label, or postage, or loosely packed container with the original purchase receipt/invoice for the service provider to conduct the return errand. Further, the user may normally specify the user's own location for pickup and the business location, including, but not limited to postal office, UPS®, FedEx®, grocery store, department store, electronics store, appliance store, etc. The user may specify other locations for pickup if the user requests item return for others including, but not limited to, parents, friends, children, etc. As can be seen in FIG. 5, in another embodiment of the present invention, the errand request sub-process receive the errand request for at least one item to be delivered to the specific consumer from a specific business with the corresponding PC device, wherein the at least one item is purchased by the specific consumer with the corresponding PC device from the specific business. Specifically, the errand request sub-process allows the specific consumer to order items from a specific business's online ordering system, and then use the present invention to have the purchased items delivered by a specific service provider. When the specific consumer places an order, the specific business makes the items ready for pickup and enters a request into the present invention. Subsequently, the specific service provider is assigned for the errand and notified for pickup.

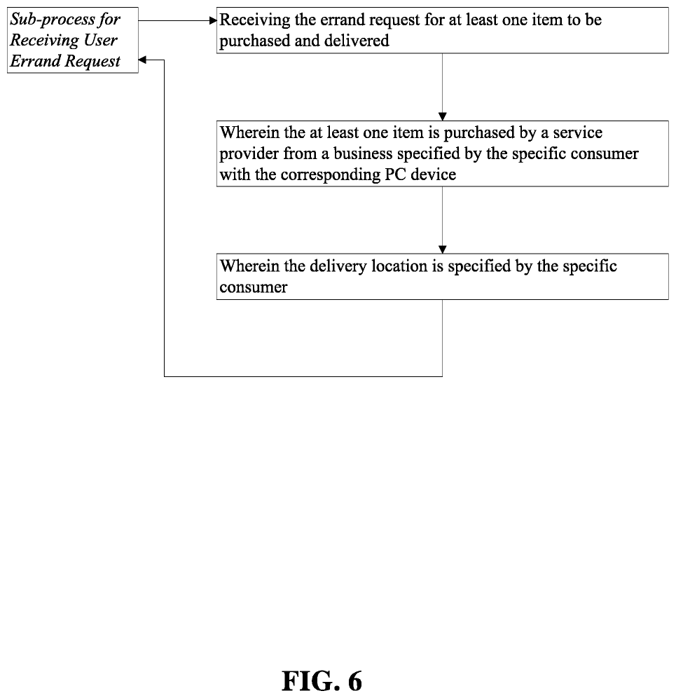

As can be seen in FIG. 6, in another embodiment of the present invention, the errand request sub-process receives the errand request for at least one item to be purchased and delivered, wherein the at least one item is purchased by a service provider from a business specified by the specific consumer with the corresponding PC device, and wherein the delivery location is specified by the specific consumer. More specifically, the errand request sub-process provides a convenient method for the specific consumer to specify desired items to be purchased by the specific service provider from a business, including, but not limited to, store, corporation, retailer, warehouse, etc., and deliver to the user's location, or another other location the user specifies. For example, the specific user may enter a request for an errand to have the specific service provider to purchase a suit specified by the specific user from a fashion store and deliver it to the user at an airport. Further, the present invention provides a method for the service provider to conduct such purchases on behalf of the specific user before Step D.

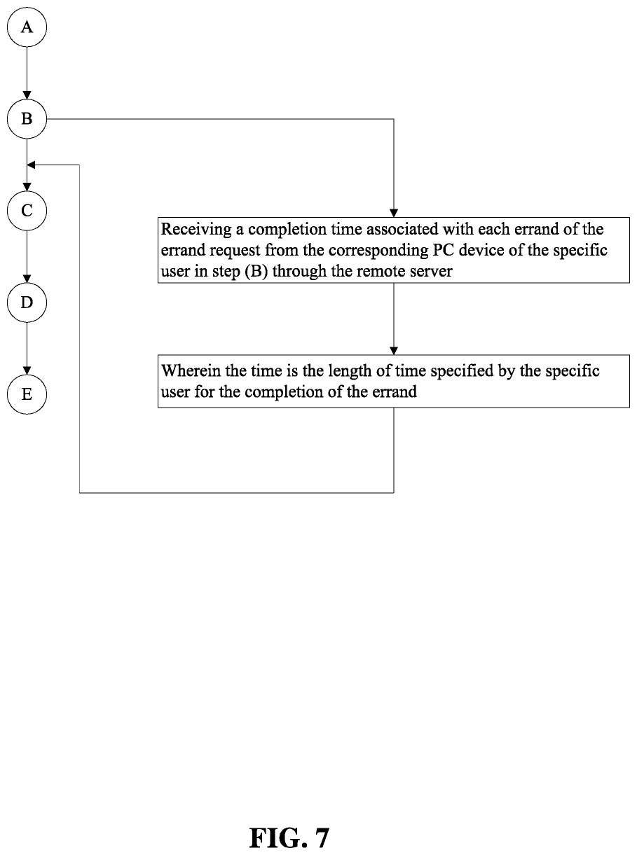

As can be seen in FIG. 7, in another embodiment of the present invention, the errand request sub-process receives a completion time associated with each errand of the errand request from the corresponding PC device of the specific user in Step B through the remote server, wherein the time is the length of time specified by the specific user for the completion of the errand. For example, the specific user may select delivery time including, but not limited to, within “1 hour”, “2 hours”, “1-2 hour”, “3-4 hours”, any customer schedule, “same day”, “next day”, “overnight”, etc.

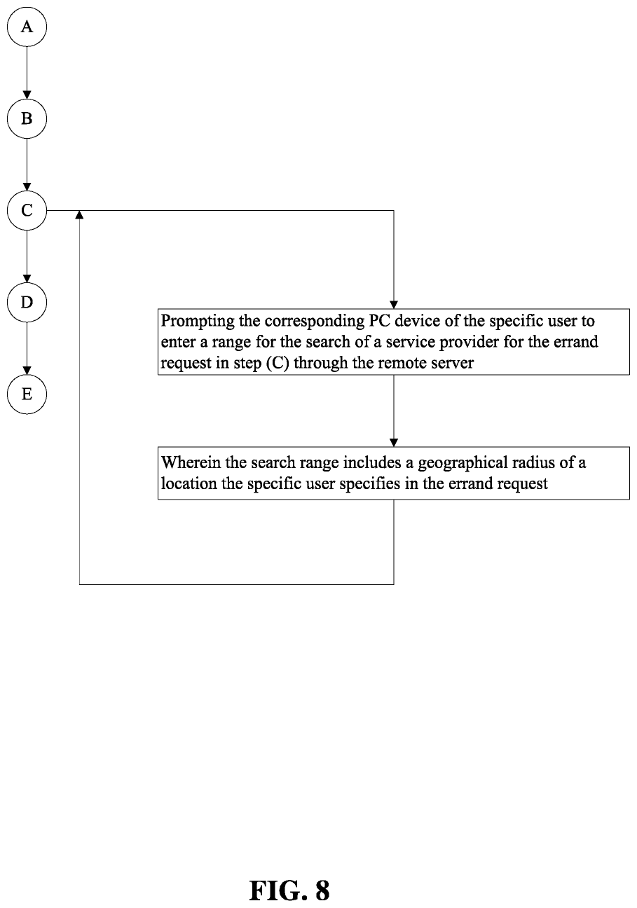

As can be seen in FIG. 8, the errand service method of the present invention provides a sub-process for matching service providers to assign the errand request of the specific user/consumer. Specifically, the method prompts the corresponding PC device of the specific user to enter a range for the search of a service provider for the errand request in Step C through the remote server, wherein the search range includes a geographical radius of a location the specific user specifies in the errand request. The errand service method includes a search range of a certain geographical radius of a specific location to search for a suitable service provider for the specific user's errand request. However, the present invention does not limit to such search. Other search criteria may include state, city, county, town, streets, school districts, communities, etc.

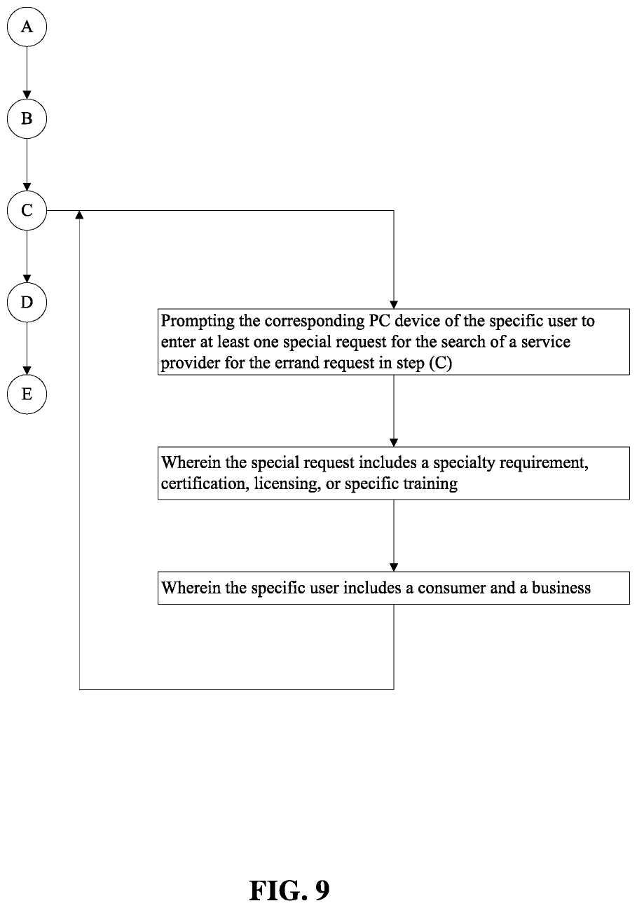

As can be seen in FIG. 9, in an alternative embodiment of the present invention, the errand service method of the present invention provides a sub-process for matching service providers to assign the errand request of the specific user/consumer. Specifically, the method prompts the corresponding PC device of the specific user to enter at least one special request for the search of a service provider for the errand request in Step C through the remote server, wherein the special request includes a specialty requirement, certification, licensing, or specific training, and wherein the specific user includes a consumer and a business. The special request specified by the specific user may include, but is not limited to, specialty, certification, professional certificate, licensing, special training, such as HIPPA (Health Insurance Portability and Accountability Act), medical training/licensing, age requirement for purchasing alcohol, etc. However, the present invention does not limit to such search.

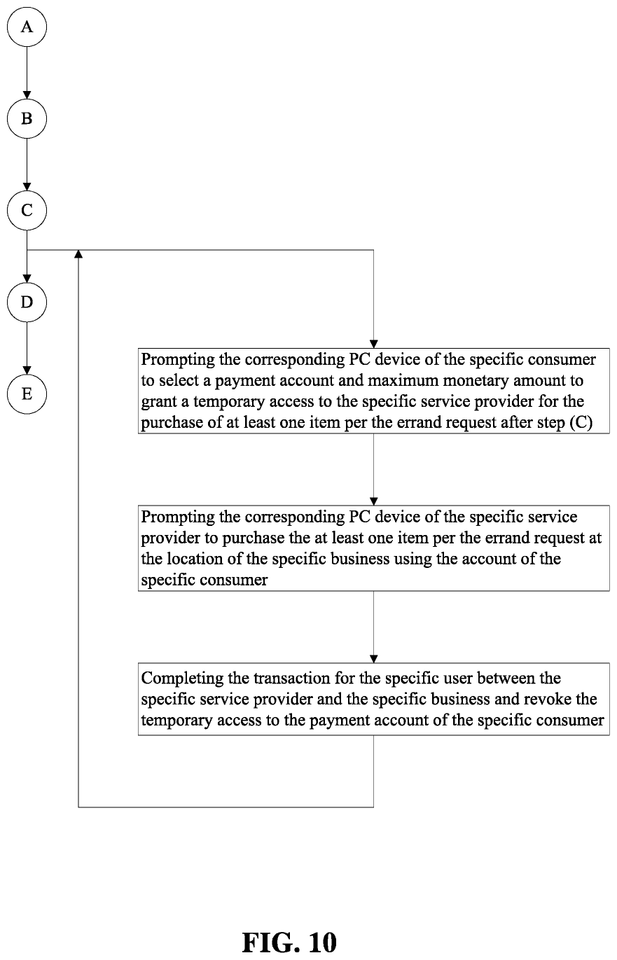

As can be seen in FIG. 10, the errand service method of the present invention provides a payment method for the specific user to incorporate the purchase of desired items into an errand. Specifically, the payment sub-process of the errand service method prompts the corresponding PC device of the specific user to select a payment account and maximum monetary amount to grant a temporary access to the specific service provider for the purchase of at least one item per the errand request after Step C, and prompts the corresponding PC device of the specific service provider to purchase the at least one item per the errand request at the location of the specific business using the account of the specific user. Subsequently, the sub-process completes the transaction for the specific user between the specific service provider and the specific business and revokes the temporary access to the payment account of the specific user. The errand service method may provide options to the specific user to select a pre-defined payment account with the system of the present invention so that a selected account may be used for the purchase of desired items for the specific user. Additionally, the errand service method allows the specific user to define a maximum monetary value that the payment account may be used for the specific purchase. Then, the errand service method grants the specific service provider to use the payment account for the purchase on behalf of the specific user with a cap of spending. Once the specific service provider finishes the purchase, the errand service account pays the account of the business from which the desired items were purchased and deducts the same account from the payment account of the specific user. Once the completion of the purchase, the present invention revokes the temporary access by the specific service provider to the payment account of the specific user for security purpose.

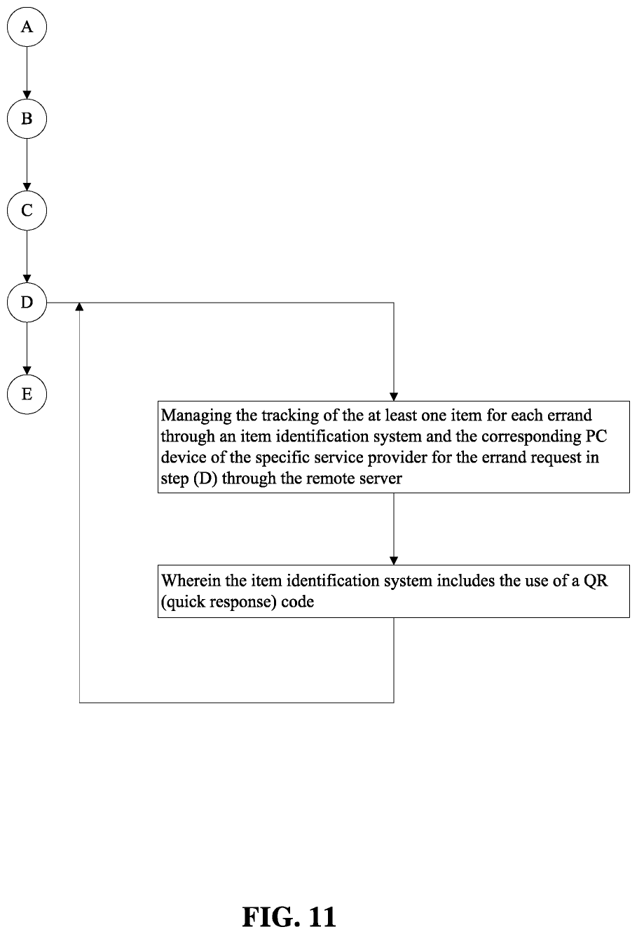

As can be seen in FIG. 11, the errand service method provides a sub-process for tracking the errands. Specifically, the errand service method manages the tracking of the at least one item for each errand through an item identification system and the corresponding PC device of the specific service provider for the errand request in step D through the remote server, wherein the item identification system includes the use of a QR (quick response) code. Besides the QR code, the present invention may use any other suitable item tracking method including, but not limited to, bar code, PC device scanning application, etc.

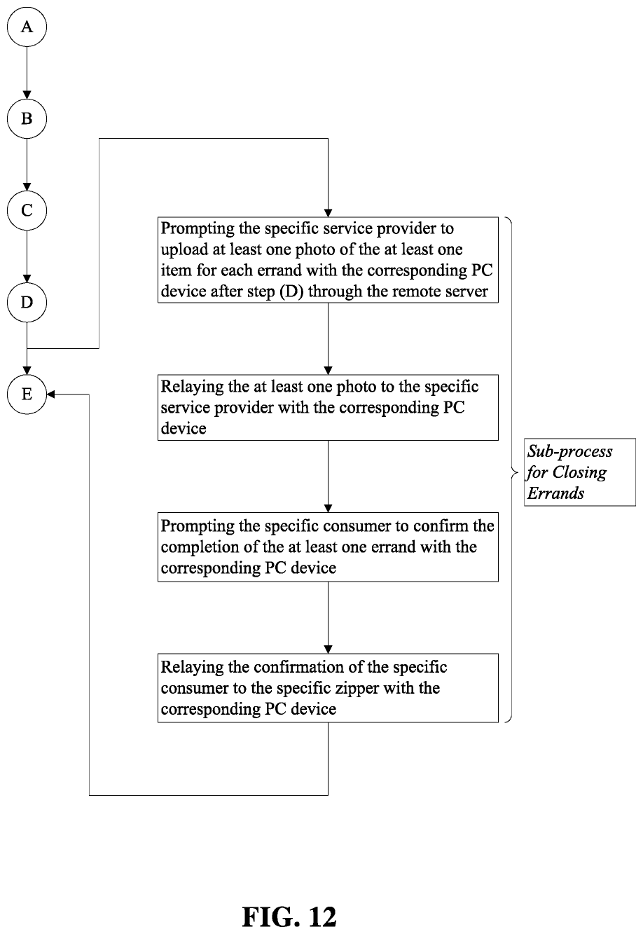

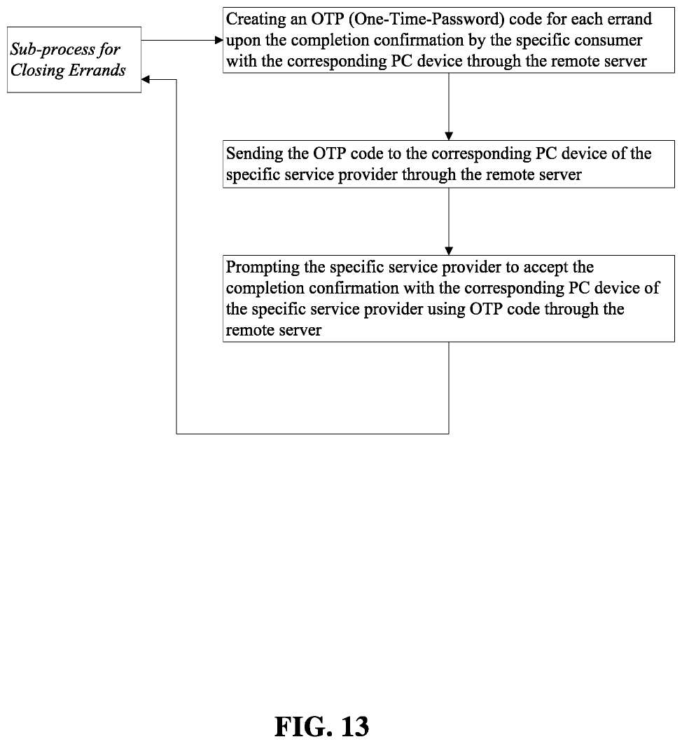

As can be seen in FIG. 12, the errand service method provides a sub-process for closing errands for both the specific user and the specific service provider. Specifically, the errand service method prompts the specific service provider to upload at least one photo of the at least one item for each errand with the corresponding PC device after Step D through the remote server. Then the errand service method relays the at least one photo to the specific user with the corresponding PC device and prompts the specific user to confirm the completion of the at least one errand with the corresponding PC device. Subsequently, the errand service method relays the confirmation of the specific user to the specific service provider with the corresponding PC device. In this sub-process, the specific service provider initiates the closing of each errand requested by the specific user. Upon the delivery of the items of the errand, the specific service provider takes photos of the item, or any relevant scenes of the successful delivery and uploads the photos to the present invention using the corresponding PC device of the specific service provider. The errand service method then relays the photos to the corresponding PC device of the specific user who originated the errand request. Additionally, the errand service method may notify the specific user to review the photos to confirm the delivery and the completion of the errands. The specific user may check the errand tracking information, contact the intended party who received the delivery, etc., to further confirm the delivery. Once the delivery is confirmed, the errand service method creates a One-Time-Password (OTP) code and sends the OTP code to the specific service provider to close out the errand request. As can be seen in FIG. 13, the sub-process of closing an errand request creating a OTP (One-Time-Password) code for each errand upon the completion confirmation by the specific user with the corresponding PC device through the remote service and sends the OTP code to the corresponding PC device of the specific service provider through the remote server. Subsequently, the errand service method prompts the specific service provider to accept the completion confirmation with the corresponding PC device of the specific service provider using OTP code through the remote server.

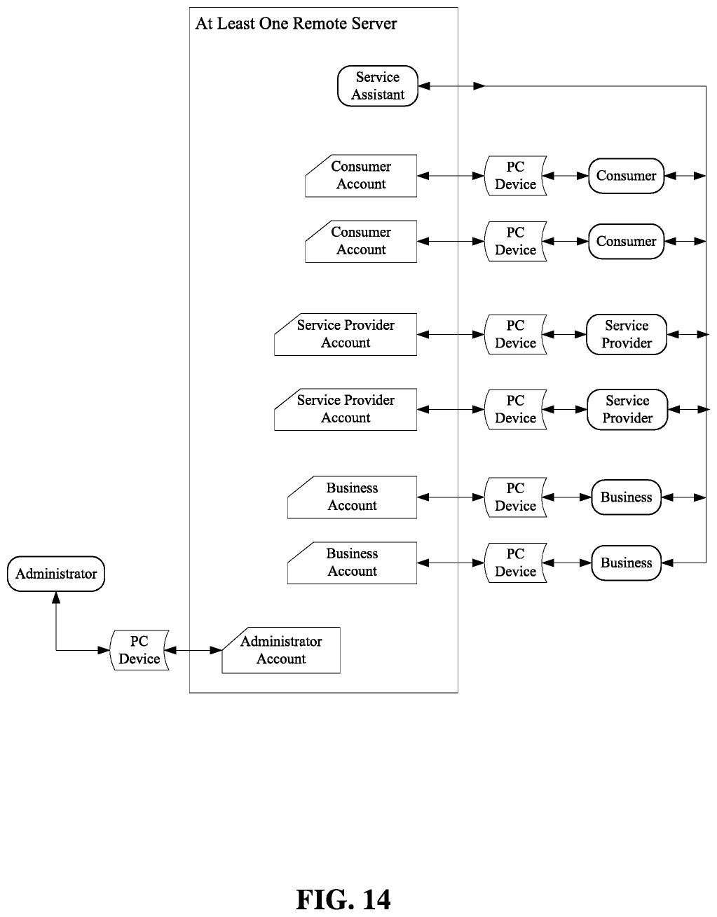

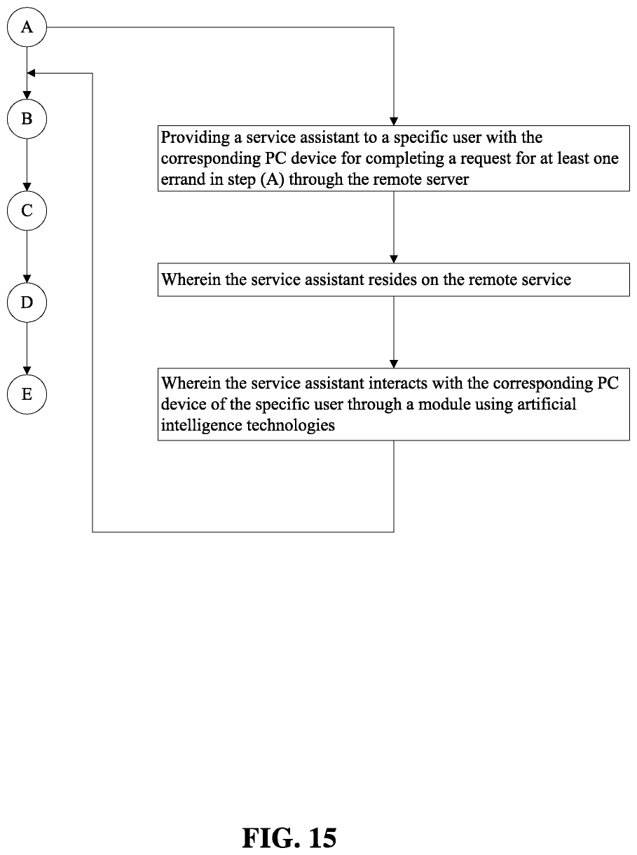

As can be seen in FIG. 14 and FIG. 15, the errand service method provides a service assistant that is an integrated element of the system resided on the at least one remote server. The service assistant is a smart application that is implemented by the errand service method to interact with the corresponding PC device of a user through an application, including, but not limited to, mobile app, wireless software application, computer software application, cloud application, server application, etc., to assist the user at every step of the errand service. More specifically, the errand service method provides a service assistant to a specific user with the corresponding PC device for completing a request for at least one errand in Step A through the remote server, wherein the service assistant resides on the remote service, and wherein the service assistant interacts with the corresponding PC device of the specific user through a module using artificial intelligence technologies.

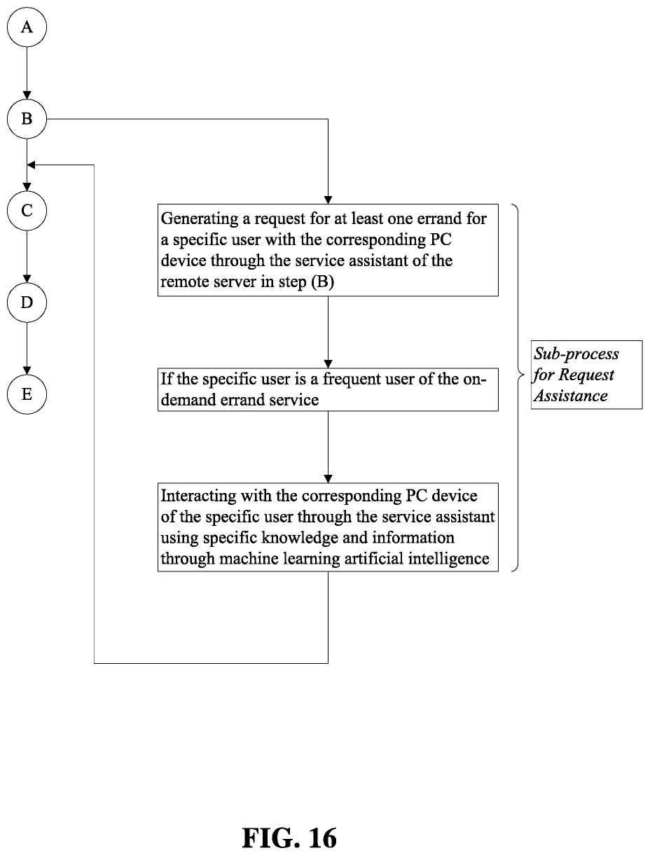

As can be seen in FIG. 16, in an alternative embodiment, the errand service method provides a sub-process for generating errand requests for the specific user using the service assistant. Specifically, the errand service method generates a request for at least one errand for a specific user with the corresponding PC device through the service assistant of the remote server in Step B. If the specific user is a frequent user of the on-demand errand service, the errand service method interacts with the corresponding PC device of the specific user through the service assistant using specific knowledge and information through machine learning artificial intelligence. The artificial intelligence technologies used in the sub-process of the present invention include, but are not limited to, machine learning, deep machine learning, meta learning, etc. The errand service method uses the knowledge and information learned through the interactions with the specific user to expedite the errand request process and minimize errors and wrong request for the specific user.

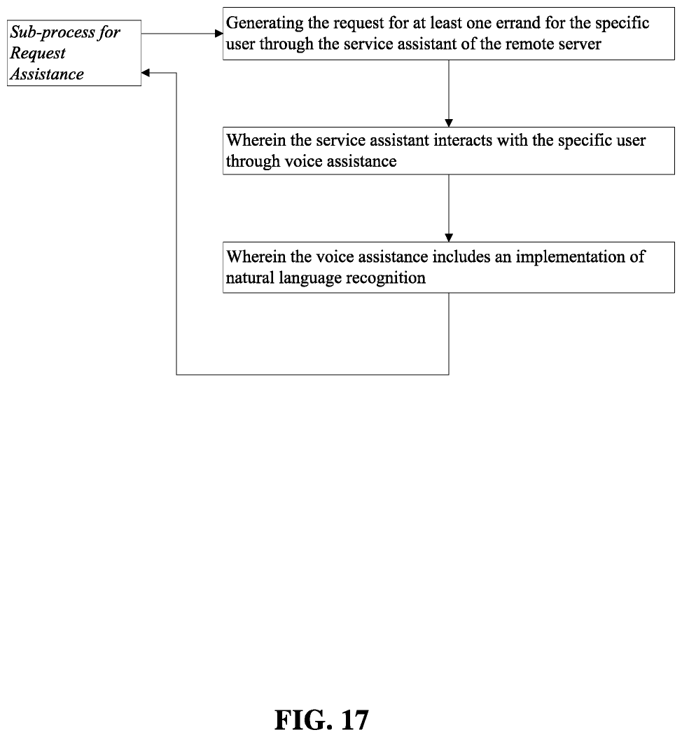

As can be seen in FIG. 17, in an alternative embodiment, the errand service method provides a sub-process for generating errand requests for the specific user using the service assistant. Specifically, the errand service method generates the request for at least one errand for the specific user through the service assistant of the remote server, wherein the service assistant interacts with the specific user through voice assistance, and wherein the voice assistance includes an implementation of natural language recognition. The artificial intelligence technologies used in this embodiment of the sub-process of the present invention include, but are not limited to, natural language recognition, human language recognition, etc. The voice assistance implanted in the service assistant of the errand service method can further expedite the errand request process for the specific user and also improve the personal experience and comfort for using the present invention.

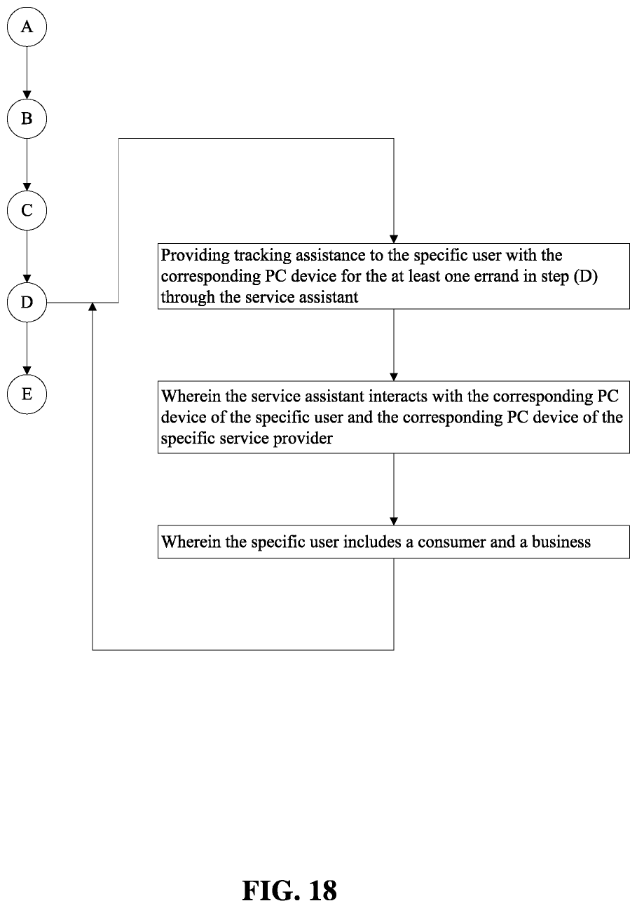

As can be seen in FIG. 18, the errand service method provides a sub-process for providing tracking assistance of each errand for the specific user using the service assistant. Specifically, the errand service method provides tracking assistance to the specific user with the corresponding PC device for the at least one errand in Step D through the service assistant, wherein the service assistant interacts with the corresponding PC device of the specific user and the corresponding PC device of the specific service provider, and wherein the specific user includes a consumer and a business. The artificial intelligence technologies used in this sub-process of the present invention may also include, but are not limited to, natural language recognition, human language recognition, etc.

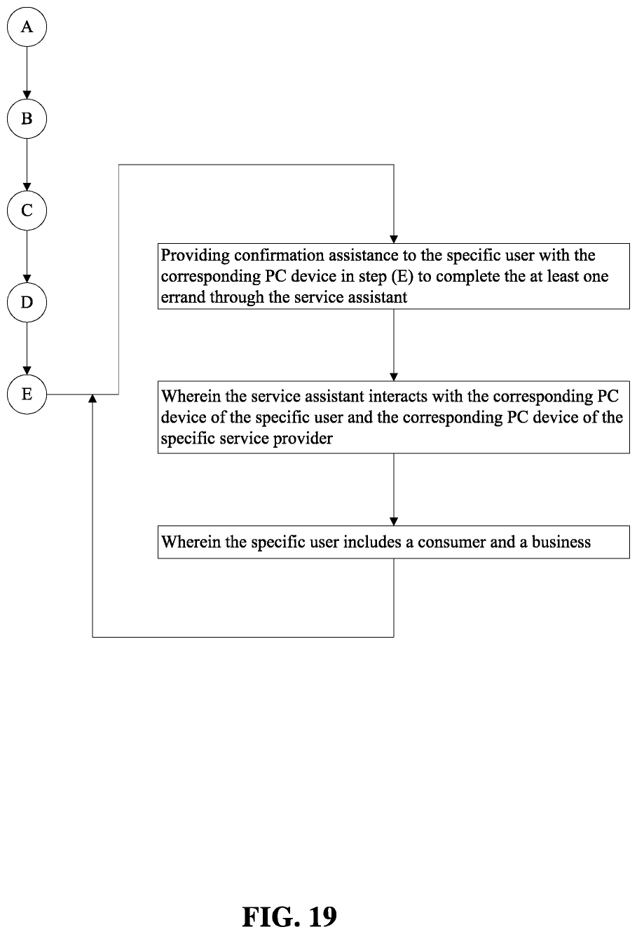

As can be seen in FIG. 19, the errand service method provides a sub-process for providing confirmation assistance of each errand for the specific user using the service assistant. Specifically, the errand service method provides confirmation assistance to the specific user with the corresponding PC device in Step E to complete the at least one errand through the service assistant, wherein the service assistant interacts with the corresponding PC device of the specific user and the corresponding PC device of the specific service provider, and wherein the specific user includes a consumer and a business. The artificial intelligence technologies used in this sub-process of the present invention may also include, but are not limited to, natural language recognition, human language recognition, etc.

Although the invention has been explained in relation to its preferred embodiment, it is to be understood that many other possible modifications and variations can be made without departing from the spirit and scope of the invention as hereinafter claimed.

What is claimed is:

1. A method for managing an on-demand errand service, the method comprising the steps of:
(A) providing a plurality of user accounts managed by at least one remote server, wherein the plurality of user accounts includes a plurality of consumer accounts, a plurality of service provider accounts, a plurality of business accounts, and wherein each of the plurality of user accounts is associated with a corresponding personal computing (PC) device;
(B) receiving a request for at least one errand from a specific user of the plurality of user accounts with the corresponding PC device through the remote server, wherein the at least one errand includes at least one item to be delivered, and wherein the specific user includes a consumer and a business;
(C) assigning the request to a specific service provider of the plurality of service provider accounts with the corresponding PC device;
(D) providing real-time item tracking to the corresponding PC device of the user through the remote server, wherein the item tracking is conducted through the corresponding PC device of the specific service provider;
(E) closing the at least one errand for both the specific user and the specific service provider upon a delivery confirmation by the remote server through the corresponding PC devices of the specific user and the specific service provider.

2. The method for managing an on-demand errand service as claimed in claim 1, the method comprising the steps of:
receiving a specified pickup location for at least one item of each errand from the corresponding PC device of the specific user in step (B); and
receiving a specified delivery location for the at least one item of each errand from the corresponding PC device of the specific user.

3. The method for managing an on-demand errand service as claimed in claim 2, the method comprising the steps of:
receiving the errand request for a return of at least one purchased item from the specific user with the corresponding PC device;
wherein the pickup location for each errand includes the location of the specific user; and
wherein the delivery location for each errand includes the location of a specific business.

4. The method for managing an on-demand errand service as claimed in claim 2, the method comprising the steps of:
receiving the errand request for at least one item to be delivered to the specific consumer from a specific business with the corresponding PC device; and
wherein the at least one item is purchased by the specific consumer with the corresponding PC device from the specific business.

5. The method for managing an on-demand errand service as claimed in claim 2, the method comprising the steps of:
receiving the errand request for at least one item to be purchased and delivered;
wherein the at least one item is purchased by a service provider from a business specified by the specific consumer with the corresponding PC device; and
wherein the delivery location is specified by the specific consumer.

6. The method for managing an on-demand errand service as claimed in claim 2, the method comprising the steps of:
receiving a completion time associated with each errand of the errand request from the corresponding PC device of the specific user in step (B) through the remote server; and
wherein the time is the length of time specified by the specific user for the completion of the errand.

7. The method for managing an on-demand errand service as claimed in claim 1, the method comprising the steps of:
prompting the corresponding PC device of the specific user to enter a range for the search of a service provider for the errand request in step (C) through the remote server; and
wherein the search range includes a geographical radius of a location the specific user specifies in the errand request.

8. The method for managing an on-demand errand service as claimed in claim 1, the method comprising the steps of:
prompting the corresponding PC device of the specific user to enter at least one special request for the search of a service provider for the errand request in step (C);
wherein the special request includes a specialty requirement, certification, licensing, or specific training; and
wherein the specific user includes a consumer and a business.

9. The method for managing an on-demand errand service as claimed in claim 1, the method comprising the steps of:
prompting the corresponding PC device of the specific consumer to select a payment account and maximum monetary amount to grant a temporary access to the specific service provider for the purchase of at least one item per the errand request after step (C);
prompting the corresponding PC device of the specific service provider to purchase the at least one item per the errand request at the location of the specific business using the account of the specific consumer; and
completing the transaction for the specific user between the specific service provider and the specific business and revoke the temporary access to the payment account of the specific consumer.

10. The method for managing an on-demand errand service as claimed in claim 1, the method comprising the steps of:
managing the tracking of the at least one item for each errand through an item identification system and the corresponding PC device of the specific service provider for the errand request in step (D) through the remote server; and
wherein the item identification system includes the use of a QR (quick response) code.

11. The method for managing an on-demand errand service as claimed in claim 1, the method comprising the steps of:
prompting the specific service provider to upload at least one photo of the at least one item for each errand with the corresponding PC device after step (D) through the remote server;
relaying the at least one photo to the specific user with the corresponding PC device;
prompting the specific user to confirm the completion of the at least one errand with the corresponding PC device; and
relaying the confirmation of the specific user to the specific service provider with the corresponding PC device.

12. The method for managing an on-demand errand service as claimed in claim 11, the method comprising the steps of:
creating an OTP (One-Time-Password) code for each errand upon the completion confirmation by the specific user with the corresponding PC device through the remote server;
sending the OTP code to the corresponding PC device of the specific service provider through the remote server; and
prompting the specific service provider to accept the completion confirmation with the corresponding PC device of the specific service provider using OTP code through the remote server.

13. The method for managing an on-demand errand service as claimed in claim 1, the method comprising the steps of:
providing a service assistant to a specific user with the corresponding PC device for completing a request for at least one errand in step (A) through the remote server;
wherein the service assistant resides on the remote service; and
wherein the service assistant interacts with the corresponding PC device of the specific user through a module using artificial intelligence technologies.

14. The method for managing an on-demand errand service as claimed in claim 13, the method comprising the steps of:
generating a request for at least one errand for a specific user with the corresponding PC device through the service assistant of the remote server in step (B);
if the specific user is a frequent user of the on-demand errand service; and
interacting with the corresponding PC device of the specific user through the service assistant using specific knowledge and information through machine learning artificial intelligence.

15. The method for managing an on-demand errand service as claimed in claim 14, the method comprising the steps of:
generating the request for at least one errand for the specific user through the service assistant of the remote server;
wherein the service assistant interacts with the specific user through voice assistance; and
wherein the voice assistance includes an implementation of natural language recognition.

16. The method for managing an on-demand errand service as claimed in claim 13, the method comprising the steps of:
providing tracking assistance to the specific user with the corresponding PC device for the at least one errand in step (D) through the service assistant;
wherein the service assistant interacts with the corresponding PC device of the specific user and the corresponding PC device of the specific service provider; and
wherein the specific user includes a consumer and a business.

17. The method for managing an on-demand errand service as claimed in claim 13, the method comprising the steps of:
providing confirmation assistance to the specific user with the corresponding PC device in step (E) to complete the at least one errand through the service assistant;
wherein the service assistant interacts with the corresponding PC device of the specific user and the corresponding PC device of the specific service provider; and
wherein the specific user includes a consumer and a business.
